(19) United States
(12) Patent Application Publication
(10) Pub. No.: US 2026/0311947 A1
(43) Pub. Date: Oct. 8, 2026

(54) CIRCUIT BREAKER AND MANUFACTURING METHOD THEREFOR

(71) Applicant: Delta Electronics (Jiangsu) Ltd., Suzhou (CN)

(72) Inventors: Xiaoxia YUAN, Suzhou (CN); SHAO-WEI CHEN, Suzhou (CN); Shaodong ZHANG, Suzhou (CN); WEI-REN JHENG, Suzhou (CN); Dandan WU, Suzhou (CN); Lixin ZHU, Suzhou (CN); ZHI-LIANG ZHANG, Suzhou (CN)

(73) Assignee: Delta Electronics (Jiangsu) Ltd., Suzhou (CN)

(21) Appl. No.: 19/571,795

(22) Filed: Mar. 19, 2026

(30) Foreign Application Priority Data
Apr. 2, 2025 (CN) 2025104134183
Apr. 2, 2025 (CN) 2025206157503

(51) Int. Cl. H01H 71/26; H01H 69/00; H01H 71/02

(52) U.S. Cl. CPC H01H 71/26; H01H 69/00; H01H 71/0207; H01H 71/025; H01H 2071/0242; H01H 2071/0292; H01H 2229/044

(57) ABSTRACT

The present disclosure provides a circuit breaker, including: a body including a winding part and an extension part, a center of the winding part is provided with a through hole, and the extension part is provided with a first pin, a second pin, a third pin and a fourth pin; a magnetic core, embedded in the winding part; a first winding, wound around the winding part and electrically connected to the first pin and the second pin; a second winding, wound around the winding part and electrically connected to the third pin and the fourth pin; a housing, including a receiving cavity, the winding part, a portion of the extension part, the magnetic core, the first winding and the second winding are provided in the receiving cavity; and a conductor, fixed to the housing and extending through the through hole.

### CROSS REFERENCE

The present application is based on and claims priority to Chinese Patent Application No. 2025104134183, filed on Apr. 2, 2025, and Chinese Patent Application No. 2025206157503, filed on Apr. 2, 2025, the entire contents of both of which are incorporated herein by reference.

### TECHNICAL FIELD

The present disclosure relates to the field of circuit safety technologies, and in particular to a circuit breaker and a method for manufacturing the circuit breaker.

### BACKGROUND

In the existing circuit breaker manufacturing process, the sensing and protection circuits of the circuit breaker are carried out by traditional manual winding, and the subsequent mechanical components are also completed by manual operation.

It should be noted that the information disclosed in the Background section above is only for enhancing the understanding of the background of the present disclosure, and thus may include information that does not constitute prior art known to those of ordinary skill in the art.

### SUMMARY

According to an aspect of the present disclosure, there is provided a circuit breaker, including:

a body, including a winding part and an extension part, wherein a center of the winding part is provided with a through hole, and the extension part is provided with a first pin, a second pin, a third pin and a fourth pin;

a magnetic core, embedded in the winding part;

a first winding, wound around the winding part and electrically connected to the first pin and the second pin;

a second winding, wound around the winding part and electrically connected to the third pin and the fourth pin;

a housing, including a receiving cavity, wherein the winding part, a portion of the extension part, the magnetic core, the first winding and the second winding are provided in the receiving cavity; and

a conductor, fixed to the housing and extending through the through hole.

According to another aspect of the present disclosure, there is further provided a method for manufacturing a circuit breaker, including:

providing a magnetic core;

encapsulating the magnetic core by injection molding to form a body, wherein the body includes a winding part and an extension part, and the winding part is formed with a through hole;

providing a first winding, winding the first winding around the winding part, and fixing two ends of the first winding to the extension part to form a first pin and a second pin;

providing a third pin and a fourth pin, and fixing the third pin and the fourth pin to the extension part;

providing a second winding, winding the second winding around the winding part, and electrically connecting two ends of the second winding to the third pin and the fourth pin, respectively; and

providing a housing, wherein a conductor is fixed to the housing, the winding part is encapsulated by the housing, and the conductor extends through the through hole.

According to another aspect of the present disclosure, there is further provided a method for manufacturing a circuit breaker, including:

providing a magnetic core;

forming a body by injection molding, wherein the body includes a winding part and an extension part, the winding part includes a receiving slot, a through hole and an insulating plate;

disposing the magnetic core in the receiving slot, and covering the receiving slot by the insulating plate;

providing a first winding, winding the first winding around the winding part, and fixing two ends of the first winding to the extension part to form a first pin and a second pin;

providing a third pin and a fourth pin, and fixing the third pin and the fourth pin to the extension part;

providing a second winding, winding the second winding around the winding part, and electrically connecting two ends of the second winding to the third pin and the fourth pin, respectively; and

providing a housing, wherein a conductor is fixed to the housing, the winding part is encapsulated by the housing, and the conductor extends through the through hole.

It should be noted that the above general description and the following detailed description are merely exemplary and explanatory and should not be construed as limiting of the disclosure.

### BRIEF DESCRIPTION OF THE DRAWINGS

The drawings herein are incorporated in and constitute a part of the specification, illustrate embodiments consistent with the present disclosure, and together with the description serve to explain principles of the present disclosure. Apparently, the drawings in the following description are only some embodiments of the present disclosure. For those of ordinary skill in the art, other drawings may be obtained based on these drawings without paying any creative effort.

FIG. 1 shows an exploded view of a structure of a circuit breaker according to an embodiment of the present disclosure.

FIG. 2 shows a schematic diagram of a body of a circuit breaker according to an embodiment of the present disclosure.

FIG. 3 shows a schematic diagram of a body and a magnetic core of a circuit breaker according to an embodiment of the present disclosure.

FIG. 4 shows a schematic diagram of a first winding of a circuit breaker according to an embodiment of the present disclosure.

FIG. 5 shows a schematic diagram of a second winding of a circuit breaker according to an embodiment of the present disclosure.

FIG. 6 shows a schematic diagram of a receiving slot and an insulating plate of a circuit breaker according to an embodiment of the present disclosure.

FIG. 7 shows a radial cross-sectional view of a winding part of a circuit breaker according to an embodiment of the present disclosure.

FIG. 8 shows a schematic diagram of a first housing of a circuit breaker according to an embodiment of the present disclosure.

FIG. 9 shows a schematic diagram of a second housing of a circuit breaker according to an embodiment of the present disclosure.

FIG. 10 shows a schematic diagram of a circuit breaker after the installation of the circuit breaker is completed according to an embodiment of the present disclosure.

FIG. 11 shows a schematic diagram of a method for manufacturing a circuit breaker according to an embodiment of the present disclosure.

FIG. 12 shows another schematic diagram of a method for manufacturing a circuit breaker according to an embodiment of the present disclosure.

### DETAILED DESCRIPTION

Example embodiments will now be described more fully with reference to the accompanying drawings. However, the example embodiments can be implemented in a variety of forms and should not be construed as being limited to examples set forth herein; rather, these embodiments are provided so that the present disclosure will be more complete and comprehensive so as to convey the idea of the example embodiments to those skilled in this art. The described features, structures or characteristics may be combined in any suitable manner in one or more embodiments.

In addition, the drawings are merely schematic representations of the present disclosure and are not necessarily drawn to scale. The same reference numerals in the drawings denote the same or similar parts, and the repeated description thereof will be omitted. Some of the block diagrams shown in the figures are functional entities and do not necessarily correspond to physically or logically separate entities. These functional entities may be implemented in software, or implemented in one or more hardware modules or integrated circuits, or implemented in different networks and/or processor devices and/or microcontroller devices.

A circuit breaker, also known as a Ground Fault Circuit breaker (GFCI), is a safety device specifically designed to protect people from electric shock. It is primarily used to detect a leakage current in a circuit and quickly cut off a power supply when an anomaly is detected. Circuit breakers are classified into portable circuit breakers and stationary circuit breakers, and are used in home, commercial, and industrial environments, including charging stations. The circuit breakers are particularly useful in damp or outdoor environments, for example, they are used in sockets and switchboards in bathrooms, kitchens, and swimming pool areas, protecting electrical devices and power plugs, etc. to prevent safety hazards caused by electric shock.

The circuit breaker is used to monitor the current flowing through the live wire and the neutral wire, respectively. Under normal circumstances, the current flowing into and out of an appliance should be equal. This is because the current starts from one electrode of the power supply, extends through the appliance, and returns to the other electrode of the power supply, forming a closed loop. When an electric shock occurs or there is the leakage current in the circuit, a part of the current will flow to the ground through an unexpected path (such as the human body), causing the current between the live and neutral wires to become unbalanced. In this housing, the current flowing through the live wire will be slightly more than the current flowing through the neutral wire, and this difference is the leakage current. Once the circuit breaker detects that the difference in the current between the live wire and the neutral wire exceeds a certain threshold (e.g., 5 milliamps), it will immediately act to cut off the circuit within a very short time (e.g., within 25 milliseconds) to prevent the occurrence of electric shock accidents. This rapid response capability greatly reduces the harm of electric shock to people.

In the traditional circuit breaker manufacturing, a protection winding and a sensing winding are manually wound onto a magnetic ring. The protection winding and the sensing winding are typically 0.1 mm to 0.3 mm insulated wires, then manually wrapped with a layer of insulating material before being sheathed. In this housing, both ends of the protection winding and the sensing winding are in a free-lead state, requiring manual wire management to wind and solder the wires in the free-lead state to the corresponding pins, and a housing is then manually installed. This entire process requires a large amount of manual labor, resulting in high labor costs and low automation, hindering the large-scale production of circuit breakers.

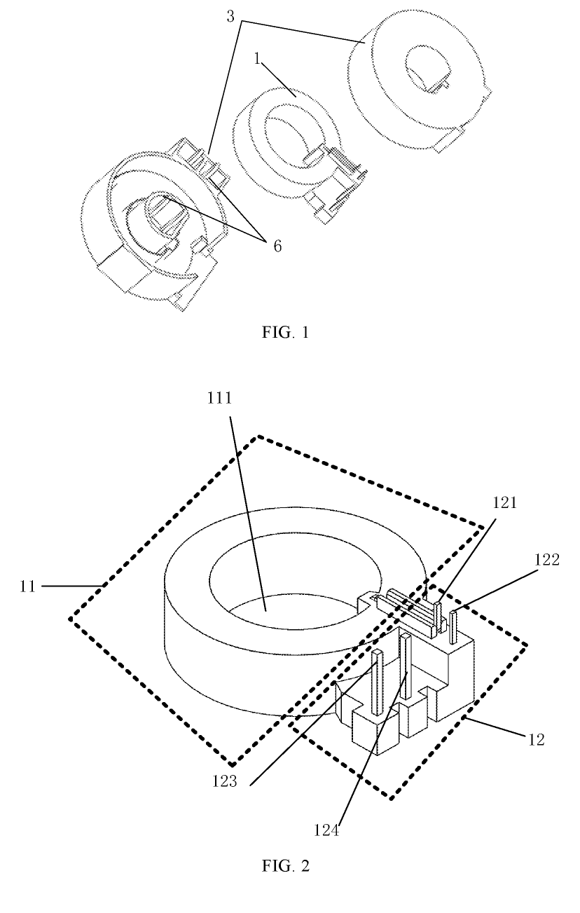

FIG. 1 shows an exploded view of a structure of a circuit breaker according to an embodiment of the present disclosure. As shown in FIG. 1, the circuit breaker includes a body 1, a housing 3, and a conductor 6.

FIG. 2 shows a schematic diagram of a body of a circuit breaker according to an embodiment of the present disclosure. As shown in FIG. 2, the body 1 includes a winding part 11 and an extension part 12. The winding part 11 has a through hole 111 at its center. The extension part 12 has a first pin 121, a second pin 122, a third pin 123 and a fourth pin 124.

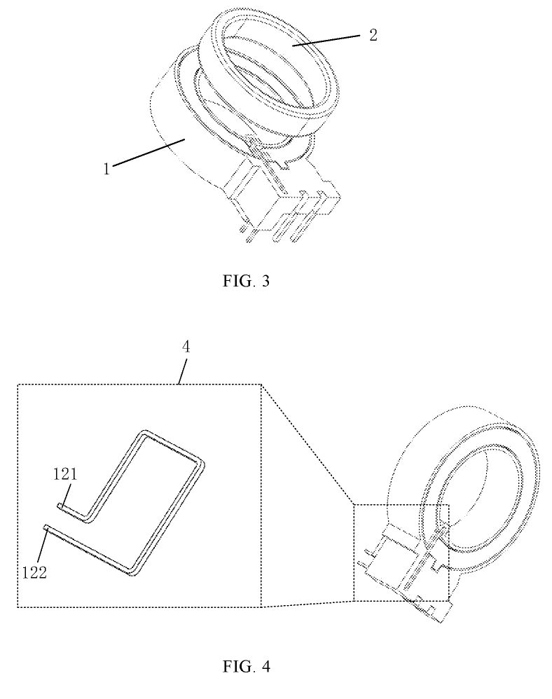

FIG. 3 shows a schematic diagram of a body and a magnetic core of a circuit breaker according to an embodiment of the present disclosure. As shown in FIG. 3, a magnetic core 2 is embedded in the winding part 11.

FIG. 4 shows a schematic diagram of a first winding of a circuit breaker according to an embodiment of the present disclosure. As shown in FIG. 4, a first winding 4 is wound around the winding part 11 and electrically connected to the first pin 121 and the second pin 122.

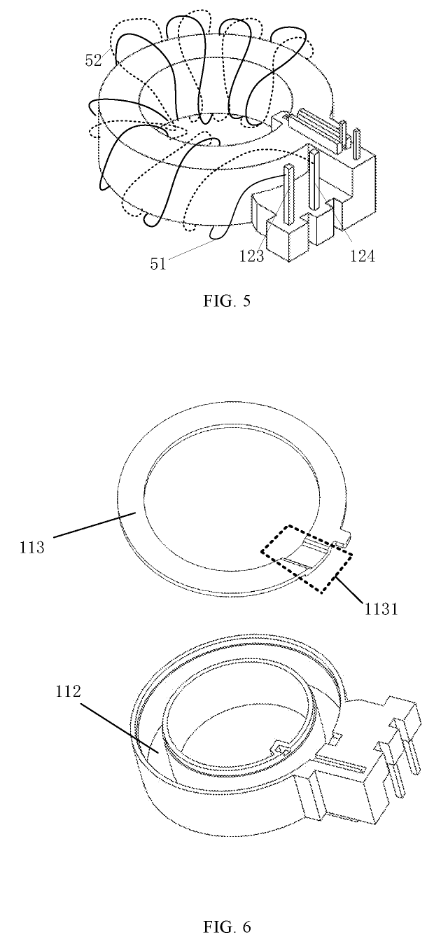

FIG. 5 shows a schematic diagram of a second winding of a circuit breaker according to an embodiment of the present disclosure. As shown in FIG. 5, a second winding 5 is wound around the winding part 11 and electrically connected to the third pin 123 and the fourth pin 124.

The housing 3 includes a receiving cavity, and the winding part 11, a portion of the extension part 12, the magnetic core 2, the first winding 4 and the second winding 5 are all placed in the receiving cavity.

A conductor 6 is fixed to the housing 3 and extends through the through hole 111.

In an embodiment, the body 1 includes an annular winding part 11, and the center of the winding part 11 is provided with the through hole 111 to form an annular structure. The winding part 11 is circumferentially provided with the extension part 12, and the extension part 12 includes the first pin 121, the second pin 122, the third pin 123, and the fourth pin 124. By providing the first pin 121, the second pin 122, the third pin 123, and the fourth pin 124 on the body, automated wire management can be achieved, avoiding traditional manual wire twisting and management.

The magnetic core 2 is embedded in the winding part 11. Specifically, the magnetic core 2 is embedded in the winding part 11 in different ways. One way is that the magnetic core 2 is integrally formed with the body 1, and another way is to first form a receiving slot 112, then place the magnetic core 2 in the receiving slot 112 and cover it with an insulating plate 113.

In an embodiment, the magnetic core 2 is integrally formed with the body 1.

If the magnetic core is made of a ferrite material, since the ferrite material can withstand a high temperature and its mechanical strength meets the requirement of the injection molding stress, the ferrite magnetic core 2 can be placed in a mold and encapsulated by injection molding to form the body 1. By integrally forming the magnetic core 2 and the body 1, efficient processing and molding of the body can be achieved.

FIG. 6 shows a schematic diagram of a receiving slot and an insulating plate of a circuit breaker according to an embodiment of the present disclosure. As shown in FIG. 6, in the embodiment, the winding part 11 includes the receiving slot 112 and the insulating plate 113. The magnetic core 2 is placed in the receiving slot 112, and the receiving slot 112 is covered by the insulating plate 113. The insulating plate 113 is disposed between the magnetic core 2 and the first winding 4 on a radial section of the winding part 11.

If the magnetic core is made of an amorphous material, the amorphous magnetic core has the relatively low mechanical strength because it is composed of multiple stacked amorphous ribbons. If the amorphous magnetic core is fully encapsulated via injection molding directly, problems such as microcracks of the amorphous magnetic core may be caused due to the effect of the injection molding stress. Therefore, it is necessary to pre-form the receiving slot to receive the amorphous magnetic core. The receiving slot 112 and the insulating plate 113 are formed by injection molding, respectively. After the receiving slot 112 solidifies, the amorphous magnetic core is placed in the receiving slot 112, and the insulating plate 113 is covered on the receiving slot 112. The cooperation between the receiving slot 112 and the insulating plate 113 forms the winding part 11 to encapsulate the amorphous magnetic core. This embodiment can avoid the problems such as microcracks of the amorphous magnetic core due to the effect of the injection molding stress.

In an embodiment, the insulating plate 113 is provided with a groove 1131, and a part of the first winding 4 is located within the groove 1131.

By providing the groove 1131 on the insulating plate 113, the first winding 4 can be flush with a surface of the insulating plate 113 after the first winding 4 is wound, which helps to reduce the height of the component. In some embodiments, the first winding 4 is an exposed metal conductor. By providing the groove 1131, the risk of short circuit caused by the first winding 4 contacting other components can be reduced.

In an embodiment, the insulating plate 113 also has a fixed protrusion, and the extension 112 also has a fixed groove. The fixed protrusion and the fixed groove cooperate to fix the position of the insulating plate 113, ensuring that a part of the first winding 4 is located within the groove 1131.

In an embodiment, the extension part 12 occupies at most 90% of a circumference of the winding part 11 in a circumferential direction. The winding part needs to reserve at least 10% of its circumference for winding the second winding 5.

In an embodiment, the first winding 4 is a sensing winding, which generates a sensing signal by sensing variations in the current in the conductor 6, and transmits the sensing signal to a controller for monitoring the current and detecting a fault.

The first winding 4 is wound around the winding part 11. Specifically, a first winding through hole is also provided at the central through hole 111 of the winding part 11, a through direction of which is the same as that of the through hole 111. The first winding through hole is formed by injection molding, and the first winding 4 extends through the first winding through hole and is wound around the winding part 11. One end of the first winding 4 is electrically connected to the first pin 121, and the other end of the first winding 4 is electrically connected to the second pin 122.

In an embodiment, the first winding 4, the first pin 121, and the second pin 122 are integrally formed.

When the first winding 4, the first pin 121, and the second pin 122 are integrally formed, the first winding 4 is composed of a metal conductor without being covered with an insulating layer. The extension part 12 also includes a second pin through hole, which extends through the extension part 12. In an embodiment, the first winding is U-shaped. The two ends of the U-shaped first winding pass through the first pin through hole and the second pin through hole, respectively. The end passing through the second pin through hole forms the second pin 122. The end passing through the first pin through hole bends and extends towards the second pin 122, reaching a predetermined position before being bent vertically to form the first pin 121. Through the above-mentioned pulling and bending, the two ends of the first winding 4 naturally form the first pin 121 and the second pin 122, that is, the first winding 4, the first pin 121, and the second pin 122 are integrally formed, which allows for automated installation of the first winding 4, eliminating the need for wire arrangement, simplifying the production process, and improving production efficiency.

In an embodiment, the first winding has one turn.

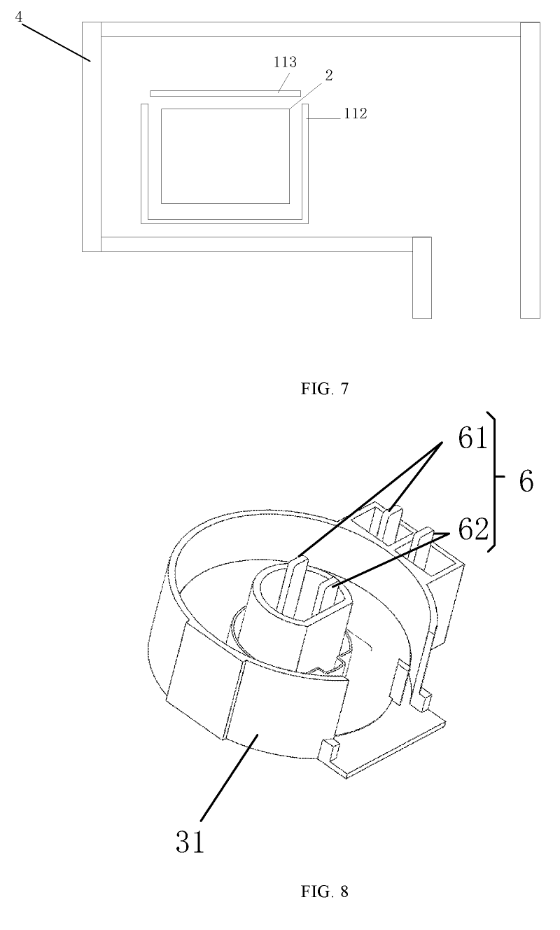

FIG. 7 shows a radial cross-sectional view of a winding part of a circuit breaker according to an embodiment of the present disclosure. As shown in FIG. 7, the first winding 4 is wound around the winding part 11 for one turn, and the insulating plate 113 is disposed between the magnetic core 2 and the first winding 4. The magnetic core 2 is encapsulated within the receiving cavity formed by the receiving slot 112 and the insulating plate 113.

In an embodiment, the second winding 5 includes a first section of wire and a second section of wire, the first section of wire is wound around the winding part 11 in a first direction, and the second section of wire is wound around the winding part 11 in a second direction.

At least part of the second section of wire covers the first section of wire, the first direction is opposite to the second direction, and both the first direction and the second direction are circumferential directions of the winding part 11.

In an embodiment, the second winding 5 is a protection winding that generates a protection signal by sensing variations in the current in the conductor 6. When it is sensed that the current difference in the conductor 6 exceeds a set threshold, it indicates the occurrence of the leakage current, and the circuit of the conductor 6 is immediately cut off to prevent the current from continuing to flow through unsafe paths, thereby avoiding dangers such as injury to personnel or fire.

The second winding 5 is wound around the winding part 11, with one end electrically connected to the third pin 123 and the other end electrically connected to the fourth pin 124. Specifically, the second winding 5 includes the first section of wire and the second section of wire.

The positional relationship of between the third pin 123 and the fourth pin 124 and the first pin 121 and the second pin 122 are not limited. For example, at least the following two housings are included: in the circumferential direction of the winding part, one housing is to place the third pin 123 and the fourth pin 124 on the same side of the first pin 121 and the second pin 122, and the other housing is to place the third pin 123 and the fourth pin 124 on opposite sides of the first pin 121 and the second pin 122, respectively. The specific positional relationship is not limited, which helps to increase the design flexibility of the circuit breaker in the present disclosure and expand its applicability.

Referring to FIG. 5, when the third pin 123 and the fourth pin 124 are both located on the same side of the first pin 121 and the second pin 122, the second winding 5 adopts the back-winding method shown in FIG. 5 during winding. First, starting from a side where the winding part 11 and the extension part 12 intersect, the first section of wire 51 is wound around the winding part 11 along the first direction (e.g., clockwise), stopping near the other side where the winding part 11 and the extension part 12 intersect. Starting from the other side where the winding part 11 and the extension part 12 intersect, the second section of wire 52 is wound around the winding part 11 along the second direction (e.g., counterclockwise), and the second section of wire 52 covers the first section of wire 51 during the winding process. If the first direction corresponds to the forward winding, then the second direction corresponds to the reverse winding. Both the forward winding and the reverse winding are performed along the circumferential direction of the winding part 11.

In an embodiment, the first section of wire 51 and the second section of wire 52 are integrally formed, that is, they are a single wire. When the first section of wire and the second section of wire are integrally formed, the two ends of the second winding 5 are electrically connected to the third pin and the fourth pin, respectively.

The third pin and the fourth pin are made of a metal material. The third pin and the fourth pin are inserted into the extension part 12 before it solidifies, and are fixed to the extension part after it solidifies.

By designing the second winding 5 to be wound around the winding part 11 and electrically connected at both ends to the third and fourth pins, respectively, the second winding 5 and the body 1 are modularized, which is beneficial for automated production.

In an embodiment, A turn ratio of the first section of wire to the second section of wire is less than or equal to 5000. In some other embodiments, The turn ratio of the first section of wire to the second section of wire is greater than or equal to 2 and less than or equal to 80.

The different winding directions are adopted and the first section of wire 51 and the second section of wire 52 are provided in a stacked manner, which can at least bring the following two beneficial effects. On the one hand, the output voltage of the protection winding can be controlled when it is ensured that the number of turns of the protection winding remains unchanged, and the output voltage can be controlled by adjusting the turn ratio of the first section of wire 51 to the second section of wire 52, so as to meet the requirements of different output voltages. On the other hand, the traditional single-layer unidirectionally wound protection winding has a large parasitic inductance and is not very sensitive to sense the leakage current under heavy load conditions (i.e., the current of the live wire and the neutral wire is large), leading to the inability to cut off the circuit in time when the electric leakage accident occurs. In the present disclosure, due to the stacked arrangement, the parasitic capacitance can be increased and the parasitic inductance can be reduced, and with the same number of turns as the traditional single-layer protection winding, the sensitivity of the protection winding to the leakage current can be improved and the output voltage of the protection winding can be increased, so that when the electric leakage accident occurs, the circuit can be cut off in time, thus playing a protective role.

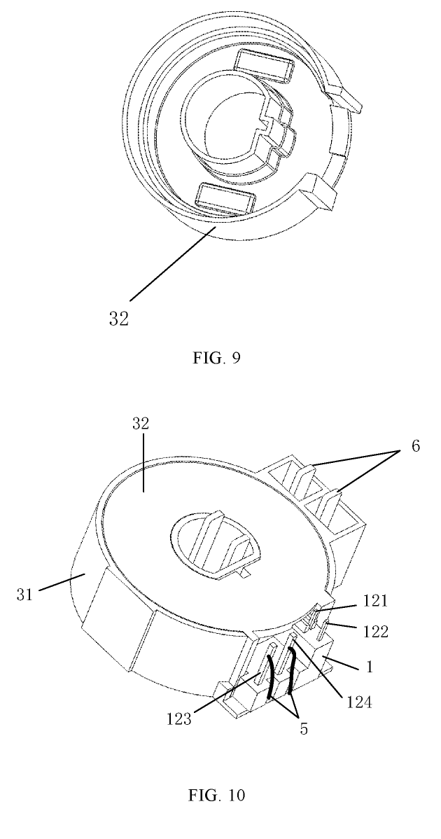

FIG. 8 shows a schematic diagram of a first housing of a circuit breaker according to an embodiment of the present disclosure. FIG. 9 shows a schematic diagram of a second housing of a circuit breaker according to an embodiment of the present disclosure. As shown in FIGS. 8 and 9, in the embodiment, the housing 3 includes a first housing 31 and a second housing 32, and the first housing 31 and the second housing 32 are snap-fitted together.

Both the inner side of the first housing 31 and the inner side of the second housing 32 are provided with shielding layers.

The first housing 31 and the second housing 32 are snap-fitted together to form the receiving cavity, within which the winding part, a portion of the extension part, the magnetic core, the first winding, and the second winding are all placed. The shielding layers, made of permalloy, are provided on both the inner side of the first housing 31 and the inner side of the second housing 32. By integrating the permalloy shielding layer with the housing, modularization of the shielding layer and the housing can be achieved, which is beneficial for automated production.

In an embodiment, the first housing 31 is integrally formed with the shielding layer, and the second housing 32 is integrally formed with the shielding layer.

During the injection molding of the first housing 31 and the second housing 32, the shielding layer is placed in the mold and injection molding is performed within the mold. The shielding layer and the first housing 31 can be integrally formed in a single injection molding process, and the shielding layer and the second housing 32 can be integrally formed by a single injection molding process.

In an embodiment, the conductor 6 is integrally formed with the first housing 31.

During the injection molding of the first housing 31, the conductor 6 is placed inside the mold, injection molding is performed within the mold, and the conductor 6 and the first housing 31 can be integrally formed in a single injection molding process. The conductor 6 includes a first conductor 61 and a second conductor 62, and the first conductor 61 and the second conductor 62 are used to connect the neutral wire and the live wire, respectively. For example, if the first conductor 61 is connected to the live wire, then the second conductor 62 is connected to the neutral wire. Alternatively, if the first conductor 61 is connected to the neutral wire, then the second conductor 62 is connected to the live wire.

FIG. 10 shows a schematic diagram of a circuit breaker after the installation of the circuit breaker is completed according to an embodiment of the present disclosure. As shown in FIG. 10, after the modular production of the first housing 31, the second housing 32 and the body 1 are completed respectively, the body 1 can be placed in the receiving cavity formed by the first housing 31 and the second housing 32 to automatically install and produce the circuit breaker.

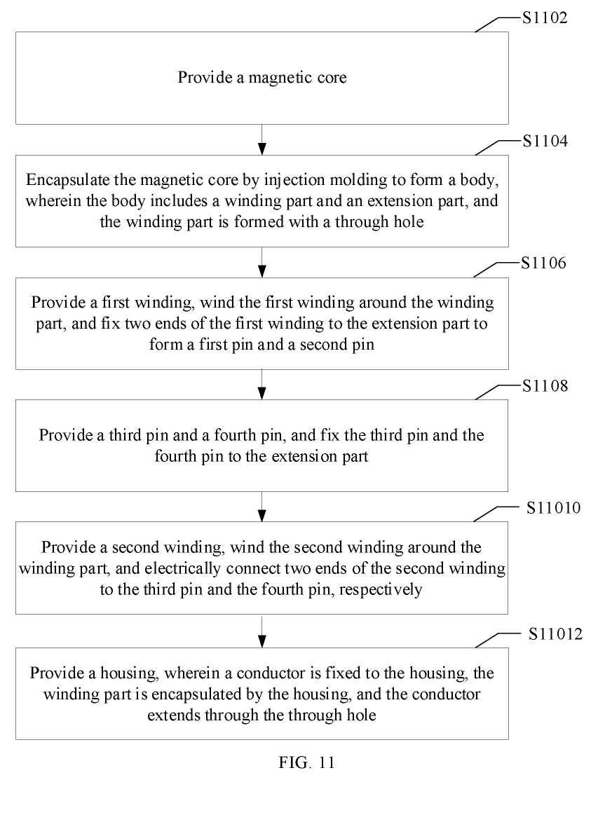

FIG. 11 shows a schematic diagram of a method for manufacturing a circuit breaker according to an embodiment of the present disclosure. As shown in FIG. 11, the method for manufacturing the circuit breaker provided in the embodiment of the present disclosure, when the magnetic core is made of the ferrite material, includes steps S1102 to S11012.

In the step S1102, a magnetic core is provided.

In the step S1104, the magnetic core is encapsulated by injection molding to form a body, the body includes a winding part and an extension part, and the winding part is formed with the through hole.

In the step S1106, a first winding is provided and wound around the winding part, and two ends of the first winding are fixed to the extension part to form a first pin and a second pin.

In the step S1108, a third pin and a fourth pin are provided and fixed to the extension part.

In the step S11010, a second winding is provided and wound around the winding part, and two ends of the second winding are electrically connected to the third pin and the fourth pin, respectively.

In the step S11012, a housing is provided, a conductor is fixed to the housing, the winding part is encapsulated by the housing, and the conductor extends through the through hole.

In an embodiment, the step of winding the second winding around the winding part includes:

in a housing where the second winding includes a first section of wire and a second section of wire, in the circumferential direction of the winding part, winding the first section of wire around the winding part along a first direction, winding the second section of wire around the winding part along a second direction opposite to the first direction, and integrally forming the first section of wire and the second section of wire.

In an embodiment, the housing includes a first housing and a second housing. Both the inner side of the first housing and the inner side of the second housing are provided with shielding layers. The first housing and the second housing are snap-fitted together, and the conductor is fixed to the first housing.

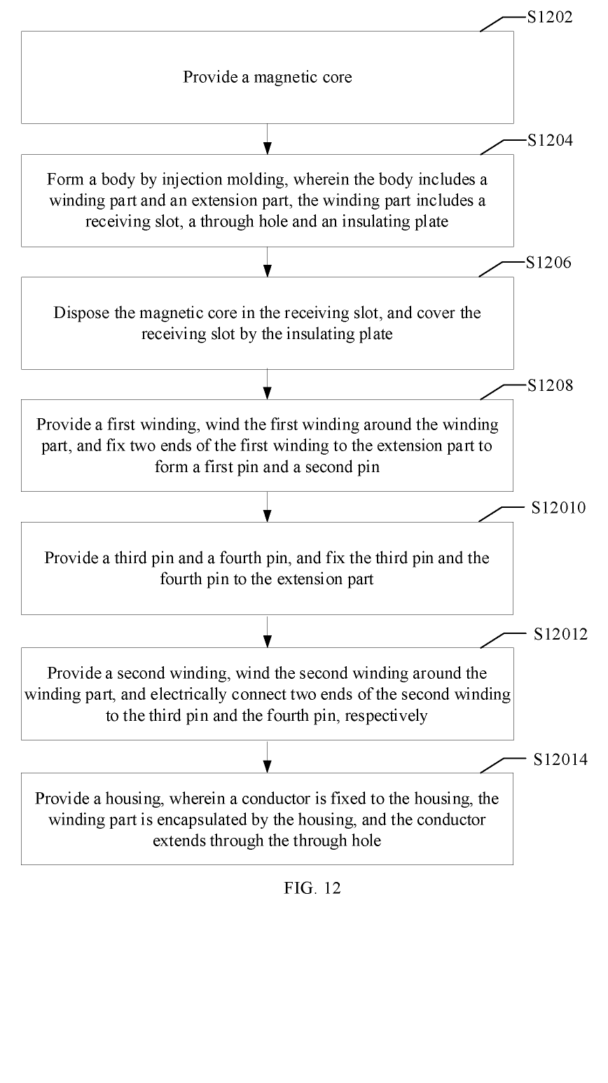

FIG. 12 shows another schematic diagram of a method for manufacturing a circuit breaker according to an embodiment of the present disclosure. As shown in FIG. 12, the method for manufacturing the circuit breaker provided in the embodiment of the present disclosure, when the magnetic core is made of the amorphous material, includes the steps S1202 to S12014.

In the S1202, a magnetic core is provided.

In the S1204, a body is formed by injection molding, the body includes a winding part and an extension part, the winding part includes a receiving slot, a through hole and an insulating plate.

In the S1206, the magnetic core is placed in the receiving slot, and the insulating plate is placed on the receiving slot.

In the step S1208, a first winding is provided and wound around the winding part, and two ends of the first winding are fixed to the extension part to form a first pin and a second pin.

In the step S12010, a third pin and a fourth pin are provided and fixed to the extension part.

In the step S12012, a second winding is provided and wound around the winding part, and two ends of the second winding are electrically connected to the third pin and the fourth pin, respectively.

In the step S12014, a housing is provided, a conductor is fixed to the housing, the winding part is encapsulated by the housing, and the conductor extends through the through hole.

In an embodiment, the magnetic core is made of the amorphous material.

In embodiments of the present disclosure, the circuit breaker is modularly designed, with the magnetic core embedded in the winding part of the body, and the first pin, the second pin, the third pin, and the fourth pin provided on the extension part of the body, realizing the integrated forming of the magnetic core, pins, and the body, and facilitating automated winding of the first and second windings around the winding part and automated wire management of the first and second windings to the corresponding pins. The conductor is fixed to the housing, and the winding part, a portion of the extension part, the magnetic core, the first winding, and the second winding are placed within the receiving cavity of the housing, achieving the automated assembly of the housing and the body after automated winding and wire management. With the modular design of the circuit breaker product, automation of circuit breaker production can be realized, reducing costs and improving quality.

It should be noted that the acquisition, storage, use, and processing of data in the technical solution of the present disclosure comply with the relevant provisions of national laws and regulations. The various types of data, such as personal identity data, operational data, and behavioral data related to individuals, customers, and groups, obtained in embodiments of the present disclosure have all been authorized.

A person skilled in the art may understand that various aspects of the present disclosure may be implemented as a system, method, or program product. Accordingly, various aspects of the present disclosure may be specifically realized in the form of a complete hardware implementation, a complete software implementation (including firmware, microcode, etc.), or a combination implementation of hardware and software, which may be collectively referred to herein as a “circuit”, “module”, or “system”.

By the foregoing description of embodiments, a person skilled in the art may easily conceive of that the example embodiment described herein may be implemented by software, or may be implemented by software in combination with the necessary hardware. Thus, a technical solution according to an embodiment of the present disclosure may be embodied in the form of a software product that may be stored in a non-volatile storage medium (which may be a CD-ROM, a USB flash drive, a removable hard drive, etc.) or on a network, and that includes a number of instructions for causing a computing device (which may be a personal computer, a server, a terminal device, or a network device, etc.) to perform the method according to an embodiment of the present disclosure.

In an example embodiment of the present disclosure, there is further provided a computer-readable storage medium, which may be a readable signal medium or a readable storage medium having a program product capable of implementing the above-mentioned method of the present disclosure stored thereon. In some implementations, various aspects of the present disclosure may also be implemented in the form of a program product including program codes which, when running on a terminal device, causes the terminal device to perform the steps according to various example embodiments of the present disclosure as described in the above-described ‘example methods’ in the specification.

More specific examples of the computer-readable storage medium in the present disclosure may include, but are not limited to, an electrical connection having one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

In the present disclosure, the computer-readable storage medium may include a data signal propagated in a baseband or as part of a carrier carrying readable program codes. Such propagated data signals may take a variety of forms, including, but not limited to, electromagnetic signals, optical signals, or any suitable combination thereof. The readable signal medium may also be any readable medium other than the readable storage medium that may transmit, propagate, or transmit a program for use by or in conjunction with an instruction-executing system, device, or apparatus.

Alternatively, the program code contained on the computer-readable storage medium may be transmitted using any suitable medium, including, but not limited to: wireless, wire, optical cable, RF, or the like, or any suitable combination thereof.

In a specific implementation, the program code for performing the operations of the present disclosure may be written in one or more programming languages or combinations thereof, including object-oriented programming languages - such as Java, C++ - and conventional procedural programming languages - such as the ‘C’ language or similar programming languages. The program code may be executed entirely on a user computing device, executed partially on the user device, executed as a stand-alone software package, executed partially on the user computing device and partially on a remote computing device, or executed entirely on a remote computing device or server. In the housing of the remote computing device, the remote computing may be connected to the user computing device via any kind of network, including a local area network (LAN) or a wide area network (WAN), or may be connected to an external computing device (e.g., by using the Internet of an Internet service provider).

It is to be noted that although a number of modules or units of the device for action execution are mentioned in the detailed description above, such division is not mandatory. Indeed, according to an embodiment of the present disclosure, the features and functions of two or more modules or units described above may be specified in a single module or unit. Conversely, the feature and function of one module or unit described above may be further divided to be specified by a plurality of modules or units.

Furthermore, although the various steps of the method in the present disclosure are described in the accompanying drawings in a particular order, it is not required or implied that the steps must be performed in that particular order or that all of the steps shown must be performed in order to achieve a desired result. Additionally or alternatively, certain steps may be omitted, a plurality of steps may be combined to be performed as a single step, and/or a single step may be broken down to be performed as a plurality of steps, and so on.

By the foregoing description of embodiments, a person skilled in the art may easily conceive of that the example embodiment described herein may be implemented by software, or may be implemented by software in combination with the necessary hardware. Thus, a technical solution according to an embodiment of the present disclosure may be embodied in the form of a software product that may be stored in a non-volatile storage medium (which may be a CD-ROM, a USB flash drive, a removable hard drive, etc.) or on a network, and that includes a number of instructions for causing a computing device (which may be a personal computer, a server, a terminal device, or a network device, etc.) to perform the method according to an embodiment of the present disclosure.

A person skilled in the art may easily conceive of other embodiments of the present disclosure upon consideration of the specification and practice of the disclosure. The present disclosure is intended to cover any variations, uses, or adaptations of the present disclosure that follow the general principles of the present disclosure and include the common knowledge or customary technical means in the art not disclosed by the present disclosure. The specification and embodiments are to be regarded as example only, and the true scope and spirit of the present disclosure is indicated by the claims.

What is claimed is:

1. A circuit breaker, comprising:
a body, comprising a winding part and an extension part, wherein a center of the winding part is provided with a through hole, and the extension part is provided with a first pin, a second pin, a third pin and a fourth pin;
a magnetic core, embedded in the winding part;
a first winding, wound around the winding part and electrically connected to the first pin and the second pin;
a second winding, wound around the winding part and electrically connected to the third pin and the fourth pin;
a housing, comprising a receiving cavity, wherein the winding part, a portion of the extension part, the magnetic core, the first winding and the second winding are provided in the receiving cavity; and
a conductor, fixed to the housing and extending through the through hole.

2. The circuit breaker according to claim 1, wherein the magnetic core is integrally formed with the body.

3. The circuit breaker according to claim 1, wherein the winding part comprises a receiving slot and an insulating plate, the magnetic core is provided in the receiving slot, the receiving slot is covered by the insulating plate, and the insulating plate is disposed between the magnetic core and the first winding on a radial section of the winding part.

4. The circuit breaker according to claim 3, wherein the insulating plate is provided with a groove, and the first winding part is located in the groove.

5. The circuit breaker according to claim 1, wherein the first winding, the first pin, and the second pin are integrally formed.

6. The circuit breaker according to claim 1, wherein the second winding comprises a first section of wire and a second section of wire, the first section of wire is wound around the winding part in a first direction, and the second section of wire is wound around the winding part in a second direction; and
the first section of wire is covered by at least part of the second section of wire, the first direction is opposite to the second direction, and the first direction and the second direction are circumferential directions of the winding part.

7. The circuit breaker according to claim 6, wherein the first section of wire and the second section of wire are integrally formed.

8. The circuit breaker according to claim 6, wherein a turn ratio of the first section of wire to the second section of wire is less than or equal to 5000.

9. The circuit breaker according to claim 8, wherein the turn ratio of the first section of wire to the second section of wire is greater than or equal to 2 and less than or equal to 80.

10. The circuit breaker according to claim 1, wherein at most 90% of a circumference of the winding part is occupied by the extension part along a circumferential direction of the winding part.

11. The circuit breaker according to claim 1, wherein the first winding has one turn.

12. The circuit breaker according to claim 1, wherein the housing comprises a first housing and a second housing snap-fitted together; and
an inner side of the first housing and an inner side of the second housing are provided with shielding layers.

13. The circuit breaker according to claim 12, wherein the first housing and the shielding layer are integrally formed, and the second housing and the shielding layer are integrally formed.

14. The circuit breaker according to claim 12, wherein the conductor is integrally formed with the first housing.

15. The circuit breaker according to claim 1, wherein the third pin and the fourth pin are provided on the same side of the first pin and the second pin in a circumferential direction of the winding part.

16. The circuit breaker according to claim 1, wherein the third pin and the fourth pin are respectively provided on opposite sides of the first pin and the second pin in a circumferential direction of the winding part.

17. A method for manufacturing a circuit breaker, comprising:
providing a magnetic core;
encapsulating the magnetic core by injection molding to form a body, wherein the body comprises a winding part and an extension part, and the winding part is formed with a through hole;
providing a first winding, winding the first winding around the winding part, and fixing two ends of the first winding to the extension part to form a first pin and a second pin;
providing a third pin and a fourth pin, and fixing the third pin and the fourth pin to the extension part;
providing a second winding, winding the second winding around the winding part, and electrically connecting two ends of the second winding to the third pin and the fourth pin, respectively; and
providing a housing, wherein a conductor is fixed to the housing, the winding part is encapsulated by the housing, and the conductor extends through the through hole.

18. The method for manufacturing the circuit breaker according to claim 17, wherein winding the second winding wire around the winding part comprises:
in a housing where the second winding comprises a first section of wire and a second section of wire, in a circumferential direction of the winding part, winding the first section of wire around the winding part along a first direction, winding the second section of wire around the winding part along a second direction opposite to the first direction, and integrally forming the first section of wire and the second section of wire.

19. The method for manufacturing the circuit breaker according to claim 17, wherein the housing comprises a first housing and a second housing, an inner side of the first housing and an inner side of the second housing are provided with shielding layers, the first housing and the second housing are snap-fitted together, and the conductor is fixed to the first housing.

20. A method for manufacturing a circuit breaker, comprising:
providing a magnetic core;
forming a body by injection molding, wherein the body comprises a winding part and an extension part, the winding part comprises a receiving slot, a through hole and an insulating plate;
disposing the magnetic core in the receiving slot, and covering the receiving slot by the insulating plate;
providing a first winding, winding the first winding around the winding part, and fixing two ends of the first winding to the extension part to form a first pin and a second pin;
providing a third pin and a fourth pin, and fixing the third pin and the fourth pin to the extension part;
providing a second winding, winding the second winding around the winding part, and electrically connecting two ends of the second winding to the third pin and the fourth pin, respectively; and
providing a housing, wherein a conductor is fixed to the housing, the winding part is encapsulated by the housing, and the conductor extends through the through hole;
circuit breaker wherein the magnetic core is made of an amorphous material.
